(19) United States
(12) Patent Application Publication
(10) Pub. No.: US 2011/0032616 A1
(43) Pub. Date: Feb. 10, 2011

(54) OPTICAL UNIT AND OPTICAL APPARATUS

(75) Inventors: Koji Sato, Fukushima-shi (JP); Yuichiro Kato, Utsunomiya-shi (JP); Katsuhiko Sato, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/844,530

(22) Filed: Jul. 27, 2010

(30) Foreign Application Priority Data
Aug. 6, 2009 (JP) 2009-183376

(51) Int. Cl. G02B 27/64

(52) U.S. Cl. 359/557

(57) ABSTRACT

The optical unit includes a base member, a shift member configured to hold an image stabilizing lens and to be movable with respect to the base member in a plane orthogonal to an optical axis to reduce image blur, and an image stabilizing actuator configured to shift the shift member. The optical unit further includes a light controlling member disposed further inside than the image stabilizing actuator in a direction orthogonal to the optical axis and in an area where the image stabilizing actuator is disposed in a direction parallel to the optical axis.

### BACKGROUND OF THE INVENTION

1. Field of the Invention

The present invention relates to an optical unit having an image stabilizing function and at least one of a shutter function and a light amount adjusting function, and to an optical apparatus including the same.

2. Description of the Related Art

Optical apparatuses such as digital cameras are often provided with a light controlling unit having at least one of a shutter function and a light amount adjusting function, and an image stabilizing unit having image blur correcting function (image stabilizing function) even though they are compact.

Japanese Patent Laid-Open no. 2007-121556 has disclosed an optical apparatus including the light controlling unit and the image stabilizing unit which are compactly and integrally collected. In this optical apparatus, since two electromagnetic actuators which shift an image stabilizing lens in two directions orthogonal to an optical axis and orthogonal to each other are compactly arranged in the image stabilizing unit, the light controlling unit is screwed onto one receiving portion formed outside a shiftable area of the image stabilizing lens in the image stabilizing unit.

However, even in the configuration disclosed in Japanese Patent Laid-Open No. 2007-121556 in which the light controlling unit and the image stabilizing unit are integrally collected, the electromagnetic actuators of the image stabilizing unit have to be located away from a position where the electromagnetic actuators interfere with the light controlling unit in the optical axis direction, which makes it impossible to further reduce a size of the optical apparatus in the optical axis direction.

### SUMMARY OF THE INVENTION

The present invention provides an optical unit having a light controlling function and an image stabilizing function, and being more compact than conventional ones, and provides an optical apparatus including the optical unit.

The present invention provides as one aspect thereof an optical unit including a base member, a shift member configured to hold an image stabilizing lens and to be movable with respect to the base member in a plane orthogonal to an optical axis to reduce image blur, an image stabilizing actuator configured to shift the shift member, and a light controlling member disposed further inside than the image stabilizing actuator in a direction orthogonal to the optical axis and in an area where the image stabilizing actuator is disposed in a direction parallel to the optical axis.

The present invention provides as another aspect thereof an optical apparatus including the above-described optical unit.

Other aspects of the present invention will become apparent from the following description and the attached drawings.

### BRIEF DESCRIPTION OF THE DRAWINGS

FIG. 1 is an exploded perspective view of a lens barrel of a digital camera that is an embodiment of the present invention.

FIG. 2 is a cross sectional view showing a configuration of the lens barrel in a retracted state.

FIG. 3 is a cross sectional view showing the configuration of the lens barrel at a wide-angle end.

FIG. 4 is a cross sectional view showing the configuration of the lens barrel at a telephoto end.

FIG. 5 is an exploded perspective view showing a configuration of a light controlling and image stabilizing unit (an aperture stop shutter unit and a shift unit) in the embodiment.

FIG. 6 is a partial cross sectional view of the shift unit in the embodiment.

FIG. 7 is a front view of the aperture stop shutter unit (in a small stop aperture state and a shutter opened state) in the embodiment.

FIG. 8 is front view of the aperture stop shutter unit (in a stop retracted state and a shutter closed state).

FIG. 9 is a front view showing a combined state of the light controlling and image stabilizing unit.

FIG. 10 is a cross sectional view of the light controlling and image stabilizing unit.

FIG. 11 is a front view showing the combined state of the light controlling and image stabilizing units.

FIG. 12 is a cross sectional view showing a modified example of the light controlling and image stabilizing unit.

FIG. 13 is a cross sectional view showing another modified example of the light controlling and image stabilizing unit.

### DESCRIPTION OF THE PREFERRED EMBODIMENTS

Exemplary embodiments of the present invention will be described hereinafter with reference to the accompanying drawings.

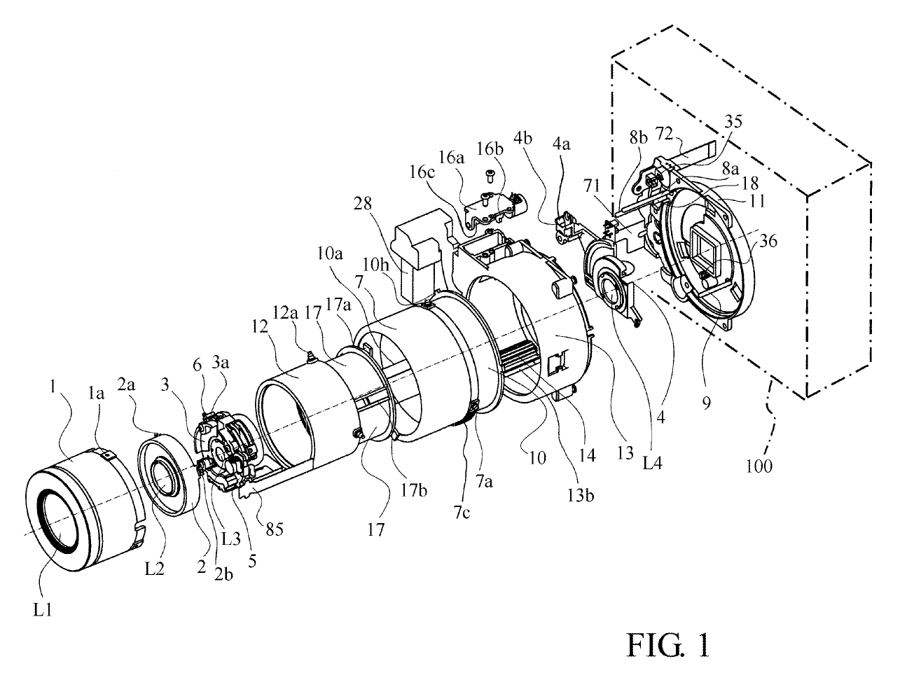

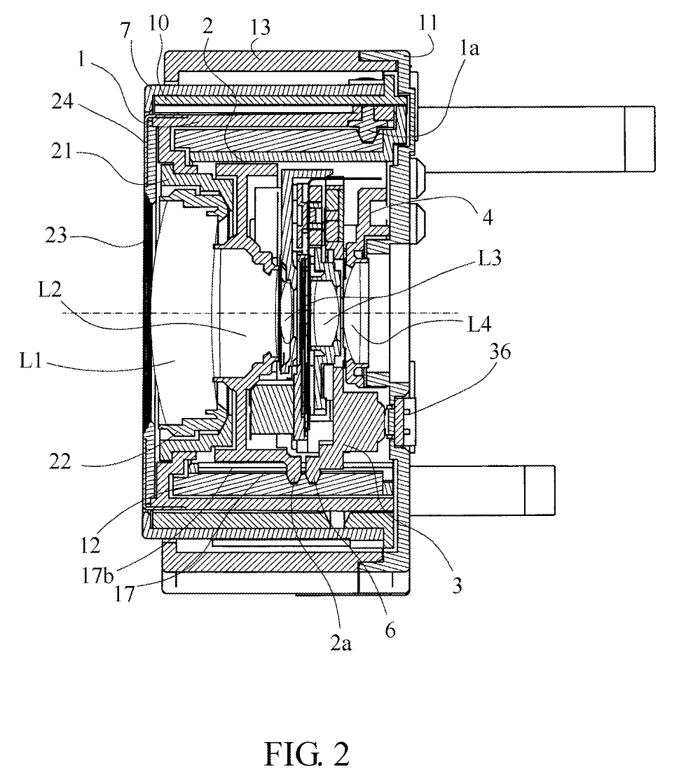

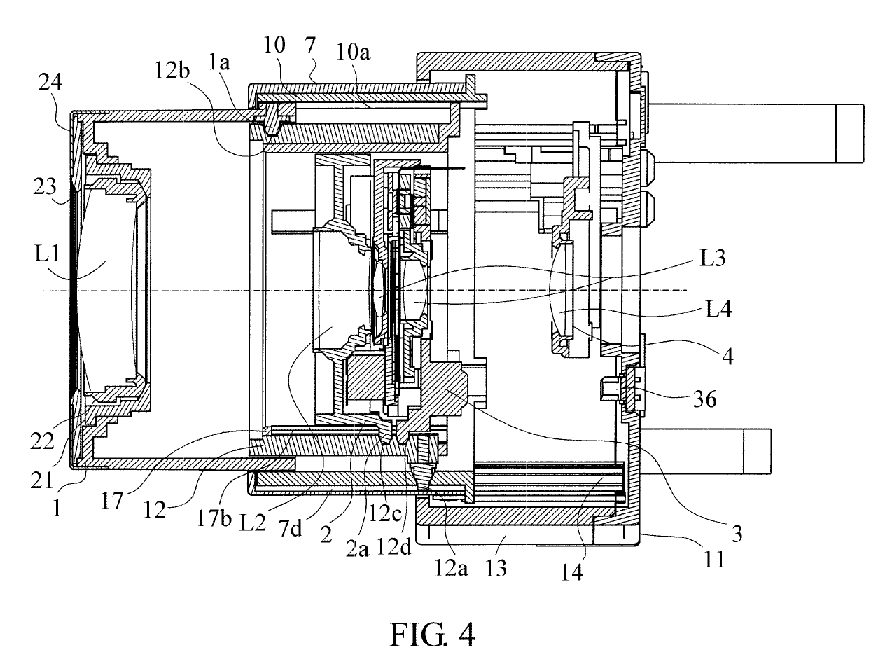

FIG. 1 shows an exploded configuration of a retractable lens barrel used for a digital camera 100 as an optical apparatus that is an embodiment of the present invention. FIGS. 2, 3 and 4 show the lens barrel in a retracted state (hereinafter referred to as a “lens retracted state” or a “lens retracted position”), at a wide-angle end and a telephoto end, respectively.

In these figures, in order from an object side (left in the figures), reference character L1 denotes a first lens unit, reference character L2 denotes a second lens unit, reference character L3 denotes a third lens unit (image stabilizing lens), and reference character L4 denotes a fourth lens unit. The first and second lens units L1 and L2 are moved in an optical axis direction with extending and shortening of the lens barrel to perform variation of magnification (that is, a zoom operation). The third lens unit L3 is shifted in a plane (directions) orthogonal to an optical axis to perform image blur correction (that is, image stabilization) to reduce image blur. The plane orthogonal to the optical axis is hereinafter referred to as the “shift plane”. The fourth lens unit L4 is moved in the optical axis direction to perform focusing.

Reference numeral 1 denotes a first holding barrel that holds the first lens unit L1, and reference numeral 2 denotes a second holding frame that holds the second lens unit L2. Reference numeral 3 denotes a shift unit as an image stabilizing unit that holds the third lens unit L3 and shifts the third lens unit L3 in the shift plane. Reference numeral 4 denotes a fourth holding frame that holds the fourth lens unit L4. Reference numeral 5 denotes an aperture stop shutter unit as a light controlling unit that has a light controlling function including a light amount adjusting function and a shutter function. The aperture stop shutter unit 5 and the shift unit 3 constitute a light controlling and image stabilizing unit as an optical unit.

Reference numeral 6 denotes a cam pin provided at an image plane side end (rear end) of the shift unit 3, and reference numeral 8a and 9 denote guide bars that guide the fourth holding frame 4 in the optical axis direction. Reference numeral 8b denotes a spring bar that guides a focus spring 18 biasing the fourth holding frame 4.

Reference numeral 11 denotes a CCD holder that holds rear ends of the guide bars 8a and 9 and the spring bar 8b, and holds an image pickup element (not shown) constituted by a photoelectric conversion element such as a CCD sensor.

Reference numeral 16a denotes a focus motor as an actuator that moves the fourth holding frame 4 in the optical axis direction, which is constituted by a stepping motor. A lead screw 16c that is rotated integrally with a rotor of the focus motor 16a engages with a nut 16b. Rotation of the lead screw 16c moves the fourth holding frame 4 in the optical axis direction through the nut 16b. The fourth holding frame 4 is provided with a rotation stopper 4a that prevents rotation of the nut 16b and a dropout stopper 4b that prevents dropout of the nut 16b from the rotation stopper 4a on the object side when an impact is applied to the camera.

The focus motor 16a is fixed to a fixed cam ring 13, which will be described later, with screws. The focus spring 18 biases the fourth holding frame 4 toward the nut 16b.

Reference numeral 35 denotes a photo-interrupter which detects that the fourth holding frame is located at a reference position in the optical axis direction. Entrance of a light-shielding portion (not shown) formed on the fourth holding frame 4 between a light-emitting portion and a light-receiving portion of the photo-interrupter 35 causes the photo-interrupter 35 to output a signal showing that the fourth holding frame 4 is located at the reference position. The output signal enables detection of a focus initial position, and thereafter, counting the number of pulses of pulse signals applied to the focus motor 16a enables focus position control.

The fixed cam ring 13 is fixed to the CCD holder 11 with screws. A sleeve cam groove portion (not shown) with which a cam pin 7a provided on a driving sleeve 7 engages is formed on an inner circumferential surface of the fixed cam ring 13.

A cam gear portion 7c is formed on an outer circumferential surface of the driving sleeve 7. A gear 14 being rotated by a driving force from a zoom motor unit 28 as a zoom actuator engages with the cam gear portion 7c. The gear 14 is held so as to be rotated at a fixed position in an opening formed in a circumferential wall of the fixed cam ring 13. The gear 14 engages with an output gear of the zoom motor unit 28 on an outer circumference side of the fixed cam ring 13, and engages with the cam gear portion 7c on an inner circumference side of the fixed cam ring 13.

A driving force being transmitted from the zoom motor unit 28 to the driving sleeve 7 through the gear 14 and the cam gear portion 7c rotates the driving sleeve 7 around the optical axis. The rotation of the driving sleeve 7 moves the driving sleeve 7 in the optical axis direction by a cam action achieved by engagement of the cam pin 7a and the sleeve cam groove portion of the fixed cam ring 13. The driving sleeve 7 is rotated around the optical axis and a straight-movable cam ring 10. The driving sleeve 7 is coupled to the straight-movable cam ring 10 through a bayonet coupling (not shown) so as to be rotatable with respect to the straight-movable cam ring 10 and movable integrally with the straight-movable cam ring 10 in the optical axis direction.

At three circumferential places of the straight-movable cam ring 10, keys 10h are formed which protrude outward in a radial direction of the straight-movable cam ring 10. These keys 10h engage with straight groove portions 13b formed at three circumferential places on the inner circumferential surface of the fixed cam ring 13 so as to extend in the optical axis direction. Thus, the straight-movable cam ring 10 is moved in the optical axis direction together with the driving sleeve 7 being rotated and moved in the optical axis direction, without being rotated with respect to the fixed cam ring 13.

Reference numeral 12 denotes a movable cam ring. A first cam groove portion 12b for moving the first holding barrel 1 in the optical axis direction is formed on an outer circumferential surface of the movable cam ring 12. A second cam groove portion 12c and a shift cam groove portion 12d for respectively moving the second holding frame 2 and the shift unit 3 in the optical axis direction are formed on an inner circumferential surface of the movable cam ring 12. A cam pin 1a that engages with the first cam groove portion 12b is provided on the first holding barrel 1. Moreover, a cam pin 2a that engages with the second cam groove portion 12c is provided on the second holding frame 2. In addition, a cam pin 6 that engages with the shift cam groove portion 12d is provided on the shift unit 3.

The movable cam ring 12 is coupled to a guiding barrel 17 through a bayonet coupling (not shown) so as to be rotatable with respect to the guiding barrel 17 and movable integrally with the guiding barrel 17 in the optical axis direction.

At three circumferential places of a rear end of the guiding barrel 17, guiding keys 17a are formed which protrude outward in a radial direction of the guiding barrel 17. The guiding keys 17a engage with straight groove portions 10a formed at three circumferential places on an inner circumferential surface of the straight-movable cam ring 10 so as to extend in the optical axis direction. Thus, the guiding barrel 17 is moved in the optical axis direction together with the movable cam ring 12 being rotated, without being rotated with respect to the straight-movable cam ring 10.

A straight-guiding key 2b is formed on the second holding frame 2. The straight-guiding key 2b engages with a straight groove portion 17b which is formed on a circumferential wall of the guiding barrel 17 so as to extend in the optical axis direction. Thus, the second holding frame 2 is not rotated even though the movable cam ring 12 is rotated.

The zoom motor unit 28 which is constituted by a stepping motor is fixed to the CCD holder 11 with screws. As described above, the output gear of the zoom motor unit 28 engages with the gear 14.

In the lens barrel configured as described above, the driving sleeve 7 is rotated by a driving force from the zoom motor unit 28, and the driving sleeve 7 and the straight-movable cam ring 10 are moved in the optical axis direction. With this motion, the movable cam ring 12 is moved together with the guiding barrel 17 in the optical axis direction while being rotated around the guiding barrel 17 by a cam action achieved by engagement of a cam pin 12a provided on the outer circumferential surface of the movable cam ring 12 and a cam groove portion (not shown) formed on a circumferential wall of the straight-movable cam ring 10 so as to penetrate therethrough.

The rotation of the movable cam ring 12 moves the first holding barrel 1 in the optical axis direction with respect to the driving sleeve 7, the straight-movable cam ring 10, the movable cam ring 12 and the guiding barrel 17. Moreover, the rotation of the movable cam ring 12 moves the second holding frame 2 and the shift unit 3 in the optical axis direction. These motions cause the lens barrel to extend and shorten among the telephoto end, the wide-angle end and the lens retracted position, and to perform the zoom operation between the telephoto end and the wide-angle end.

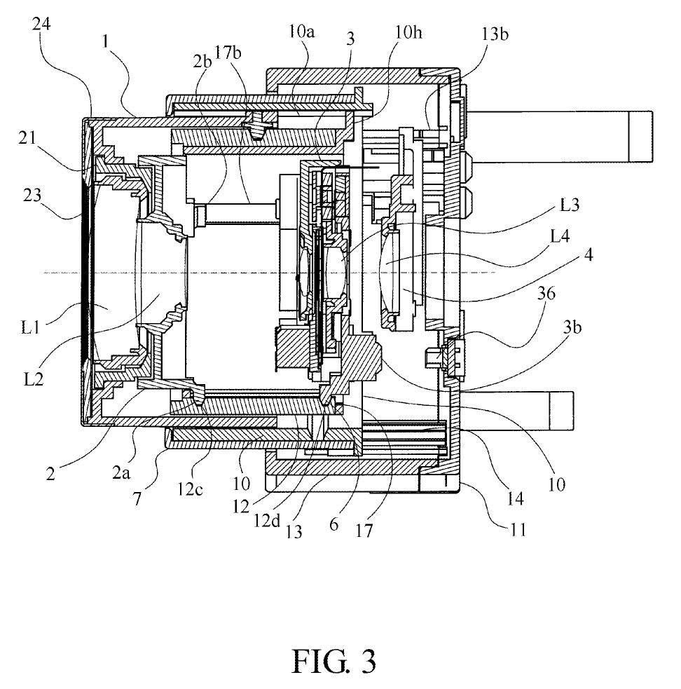

Reference numeral 36 denotes a photo-interrupter which detects that the shift unit 3 is located at a reference position in the optical axis direction. Entrance of a light-shielding portion 3b (shown in FIG. 3) formed on the shift unit 3 between a light-emitting portion and a light-receiving portion of the photo-interrupter 36 causes the photo-interrupter 36 to output a signal showing that the shift unit 3 is located at the reference position. The output signal enables detection of a zoom initial position, and thereafter, counting the number of pulses of pulse signals applied to the zoom motor unit 28 enables zoom position control.

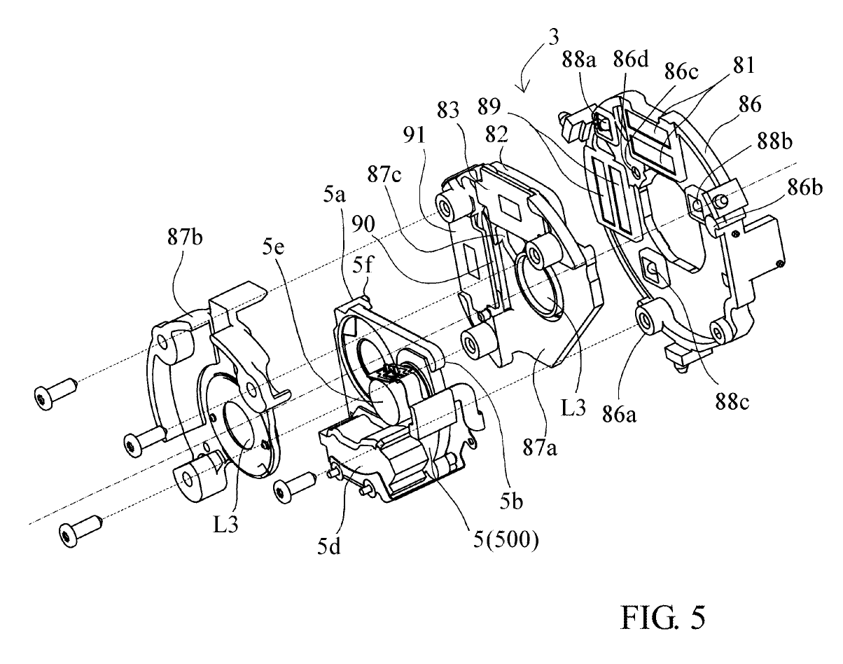

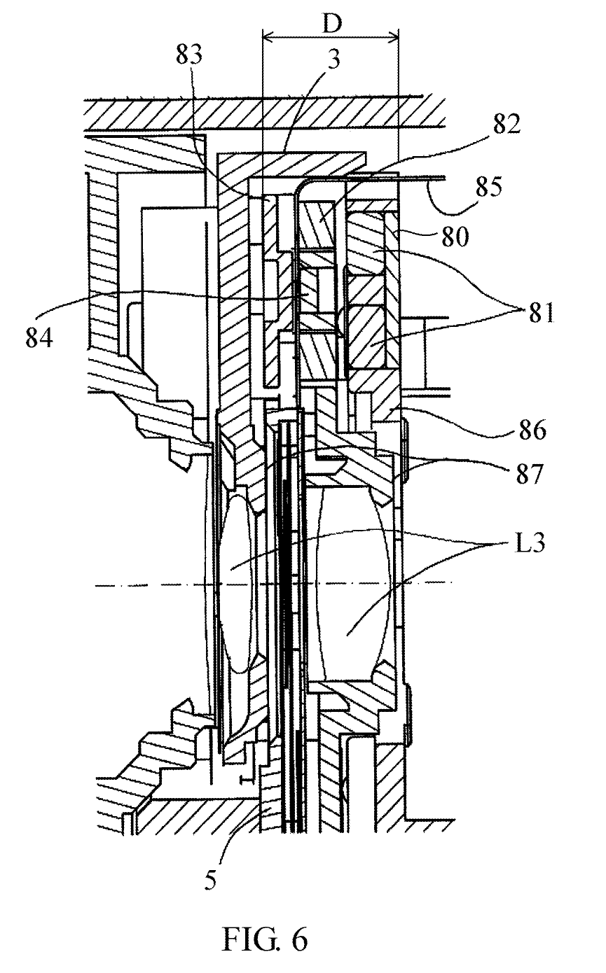

FIG. 5 shows an exploded configuration of the light controlling and image stabilizing unit constituted by the aperture stop shutter unit 5 and the shift unit 3. FIG. 6 shows a cross section of the shift unit 3.

In the shift unit 3, an object side lens element of the third lens unit L3 is held by a front shift barrel 87b, and an image side lens element of the third lens unit L3 is held by a rear shift barrel 87a serving as a shift member. The front shift barrel 87b and the rear shift barrel 87a are joined each other with screws, and are integrally shiftable (movable) in the shift plane with respect to a shift base 86 which will be described later.

Coils 82 and 90 and upper yokes 83 and 91 which are elements constituting part of shift actuators are held by the rear shift barrel 87a at two places whose phases around the optical axis are mutually different by 90 degrees. The coils 82 and 90 are arranged on a shift base (86) side of the rear shift barrel 87a, and the upper yokes 83 and 91 are arranged on a front shift barrel (87b) side thereof.

The shift base 86 is a base member (first base member) of the shift unit 3. Magnets 81 and 89 which are elements constituting other part of the shift actuators are held by the shift base 86 at two places whose phases around the optical axis are mutually different by 90 degrees, the two places facing the coils 82 and 90. Moreover, a back yoke 80 is fixed to back faces of the magnets 81 and 89.

The coil 82, the upper yoke 83, the magnet 81 and the back yoke 80 constitute a pitch shift actuator serving as a first image stabilizing actuator which shifts the shift barrels 87a and 87b in a vertical direction. The vertical direction corresponds to a first direction (hereinafter referred to as a “pitch direction”). The coil 90, the upper yoke 91, the magnet 89 and the back yoke 80 constitute a yaw shift actuator serving as a second image stabilizing actuator which shifts the shift barrels 87a and 87b in a horizontal direction. The horizontal direction corresponds to a second direction (hereinafter referred to as a “yaw direction”). Thus, the shift unit 3 is provided with the two shift actuators at two places whose phases around the optical axis are mutually different by 90 degrees.

Balls 88a, 88b and 88c are respectively disposed in ball holding frames formed at three circumferential places on the shift base 86, each ball being rollable inside each ball holding frame. The rear shift barrel 87a is brought into press contact with the balls 88a, 88b and 88c by attractive forces acting between the magnets 81 and 89 and the upper yokes 83 and 91. Thereby, the shift barrels 87a and 87b are guided in the pitch and yaw directions by the balls 88a, 88b and 88c while being prevented from tilting with respect to the shift plane.

Reference numeral 85 denotes a shift FPC to energize the coils 82 and 90. Two hall elements 84 are mounted on the shift FPC 85. The two hall elements 84 are respectively disposed in inner openings of the coil 82 and 90, and respectively output detection signals in response to changes of magnetism caused by shifting of the shift barrels 87a and 87b in the pitch and yaw directions. Using the detection signals makes it possible to detect shift positions of the shift barrels 87a and 87b in the pitch and yaw directions.

The camera 100 is provided with a shake detection sensor (not shown) which is constituted by an angular velocity sensor or the like. The shake detection sensor detects camera shaking in the pitch and yaw directions. A control circuit (not shown) calculates a shift direction and a shift amount of the shift barrels 87a and 87b for reducing image blur depending on a direction and an amount of the camera shaking detected by the shake detection sensor, and then controls energization of the coils 82 and 90 on the basis of the calculation results. The control circuit uses an actual shift amount of the shift barrels 87a and 87b detected by the hall element 84 in each of the pitch and yaw directions to perform feedback control of the energization of each of the coils 82 and 90. Thus, an image stabilizing function is realized.

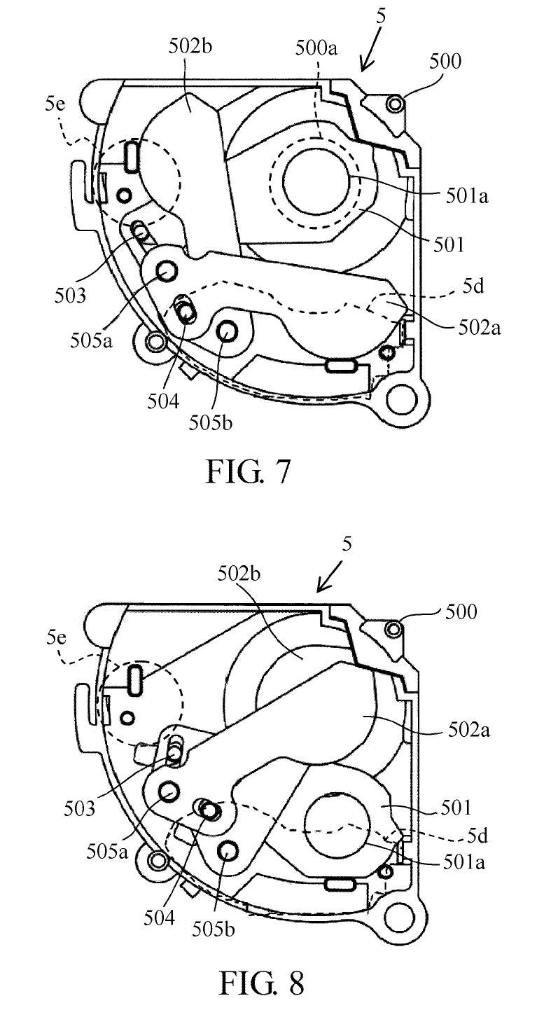

FIGS. 7 and 8 show configurations of the aperture stop shutter unit 5 when being viewed in the optical axis direction (that is, a light passing direction). Reference numeral 500 denotes an aperture stop shutter base that is a base member (second base member) of the aperture stop shutter unit 5. A fixed aperture 500a through which light passes is formed in the aperture stop shutter base 500.

Reference numeral 501 denotes a light amount adjusting member serving as a light controlling member. A small stop aperture 501a having a diameter smaller than that of the fixed aperture 500a (that is, reducing an amount of light passing therethrough) is formed in the light amount adjusting member 501. Although this embodiment describes the case where the small stop aperture 501a is formed in the light amount adjusting member, a filter member such as an ND filter which attenuates an amount of light being transmitted therethrough may be used as the light amount adjusting member.

The light amount adjusting member 501 is rotatable around an axle portion (first axle) 505a formed on the aperture stop shutter base 500.

Specifically, the light amount adjusting member 501 is rotatable between a light attenuating position (small stop aperture state) at which part of the light amount adjusting member 501 where the small stop aperture 501a is formed covers the fixed aperture 500a as shown FIG. 7 and a retracted position at which the part thereof where the small stop aperture 501a is formed is retracted from the fixed aperture 500a as shown FIG. 8.

An elongate hole portion is formed in the light amount adjusting member 501, and a driving axle portion formed on a light amount adjusting member driving lever 503 engages with the elongate hole portion. The engagement portion of the elongate hole portion and the driving axle portion corresponds to a second engagement portion. The light amount adjusting member driving lever 503 constitutes an output portion of an aperture stop motor 5e serving as an aperture stop driving source, and transmits a rotating force of the aperture stop motor 5e to the light amount adjusting member 501 to rotate it around an axle portion 505a formed on the aperture stop shutter base 500. The aperture stop motor 5e corresponds to a second light controlling actuator.

Reference numerals 502a and 502b respectively denote a first shutter member and a second shutter member which are also light controlling members. The first shutter member 502a is rotatable around the axle portion 505a formed on the aperture stop shutter base 500, the axle portion 505a being a common axle portion for the first shutter member 502a and the light amount adjusting member 501. On the other hand, the second shutter member 502b is rotatable around an axle portion (second axle) 505b formed on the aperture stop shutter base 500. The first and second shutter members 502a and 502b are rotatable between an opening position (shutter opened state) opening the fixed aperture 500a as shown in FIG. 7 and a closing position (shutter closed state) covering and closing the fixed aperture 500a as shown in FIG. 8.

Elongate hole portions are formed in the first and second shutter members 502a and 502b. A driving axle portion formed on a shutter driving lever 504 engages with the elongate hole portions. The engagement portion of the elongate hole portions and the driving axle portion corresponds to a first engagement portion. The shutter driving lever 504 constitutes an output portion of a shutter motor 5d serving as a shutter driving source. The shutter motor 5d corresponds to a first light controlling actuator. The shutter driving lever 504 transmits a rotating force of the shutter motor 5d to the first and second shutter members 502a and 502b to rotate them respectively around the axle portions 505a and 505b.

The axle portion 505b forming a rotation center of the second shutter member 502b is located on a side opposite to the axle portion 505a forming a rotation center of the first shutter member 502a with respect to the first engagement portion with which the shutter driving lever 504 and the first and second shutter members 502a and 502b engage. Moreover, the second engagement portion with which the light amount adjusting member 501 and the light amount adjusting member driving lever 503 engage is located on a side opposite to the first engagement portion with respect to the axle portion 505a.

Then, the light amount adjusting member 501 is rotated around the axle portion 505a in a direction approaching the axle portion 505b, as shown in FIG. 8, from the light attenuating position to the retracted position. In other words, the light amount adjusting member 501 is rotated from an aperture stop motor (5e) side to a shutter motor (5d) side when being rotated from the light attenuating position to the retracted position.

The above-described configuration of the aperture stop shutter unit 5 makes it possible to overlap a rotation area of the light amount adjusting member 501 with a rotation area of the first shutter member 502a by 50% or more. This enables a sector-shaped (fan-like) configuration of the aperture stop shutter unit 5 (aperture stop shutter base 500) having a center (pivot) located on an opposite side to the axle portions 505a and 505b and the first and second engagement portions, and having a central angle (spread angle) of 90 degrees, when being viewed in the optical axis direction. Thus, this embodiment can miniaturize the aperture stop shutter unit 5 particularly in the direction orthogonal to the optical axis.

The central angle of the sector-shaped configuration may be an angle other than 90 degrees, such as an obtuse angle of 100 degrees, an acute angle of 80 degrees or the like.

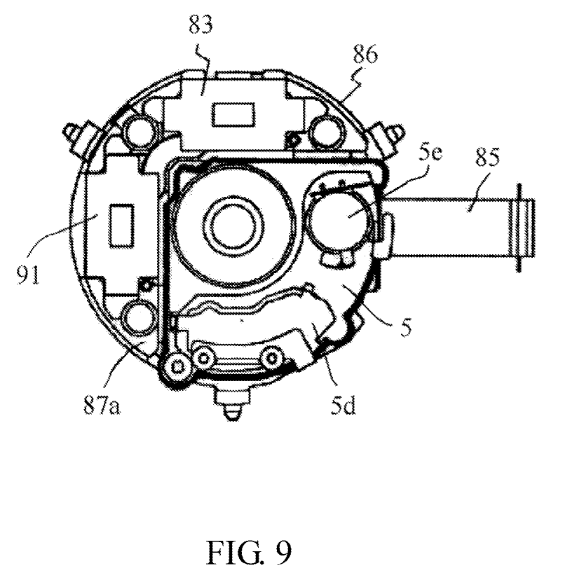

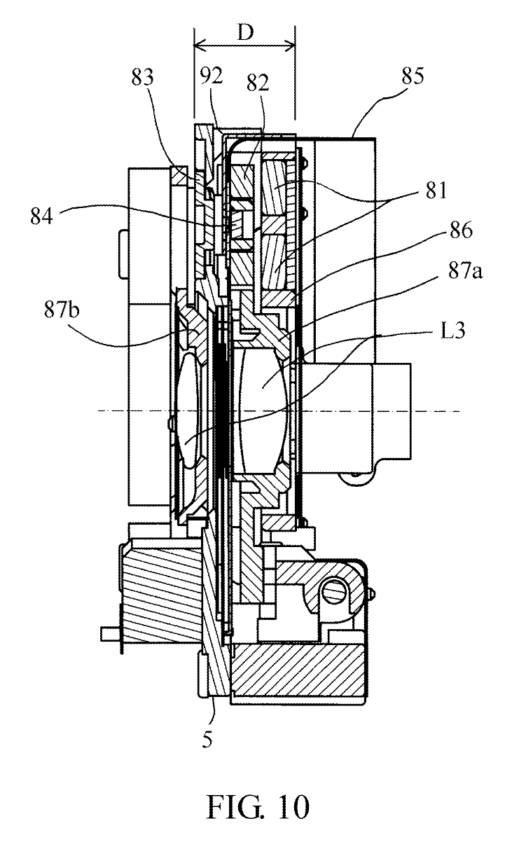

The sector-shaped aperture stop shutter unit 5 is disposed, as shown in FIGS. 9 and 10, in a sector-shaped space whose central angle is 90 degrees and which faces optical axis side end faces of the two shift actuators, the optical axis side end faces being inside edges of the two shift actuators in a radial direction of the shift unit 3. This makes it possible to dispose at least part of the aperture stop shutter unit 5 (for example, at least the light amount adjusting member 501 and the shutter members 502a and 502b) in a thickness D in the optical axis direction of the shift actuators, as shown in FIGS. 10 and 6.

In other words, the light amount adjusting member 501 and the shutter members 502a and 502b are disposed further inside than the shift actuators in the direction orthogonal to the optical axis and within an area (thickness D) where the shift actuators are disposed in a direction parallel to the optical axis. The thickness D of the shift actuators corresponds to a distance from front end faces (object side end face) of the upper yokes 83 and 91 to a rear end face (image plane side end face) of the back yoke 80.

Such a configuration enables the aperture stop shutter unit 5 to be disposed close to the rear shift barrel 87a while avoiding interference of the aperture stop shutter unit 5 with the two shift actuators. Therefore, thicknesses in the optical axis direction of the aperture stop shutter unit 5 and the shift unit 3 can be reduced, thereby resulting in reduction of a total length in the optical axis direction of the lens barrel in the lens retracted state.

The control circuit (not shown) provided in the camera 100 controls the aperture stop motor 5e to rotate the light amount adjusting member 501 to the light attenuating position or the retracted position on the basis of luminance information obtained by an output signal from the image pickup element in video capturing. Such control of the aperture stop motor 5e enables formation of an object image having an appropriate brightness on the image pickup element, thereby making it possible to produce good video by using the output signal from the image pickup element. Moreover, the control circuit controls the shutter motor 5d such that the first and second shutter members 502a and 502b are rotated from the closing position to the opening position and then returned to the closing position with a predetermined shutter speed in still image capturing. Such control of the shutter motor 5d enables production of a good still image by using the output signal from the image pickup element.

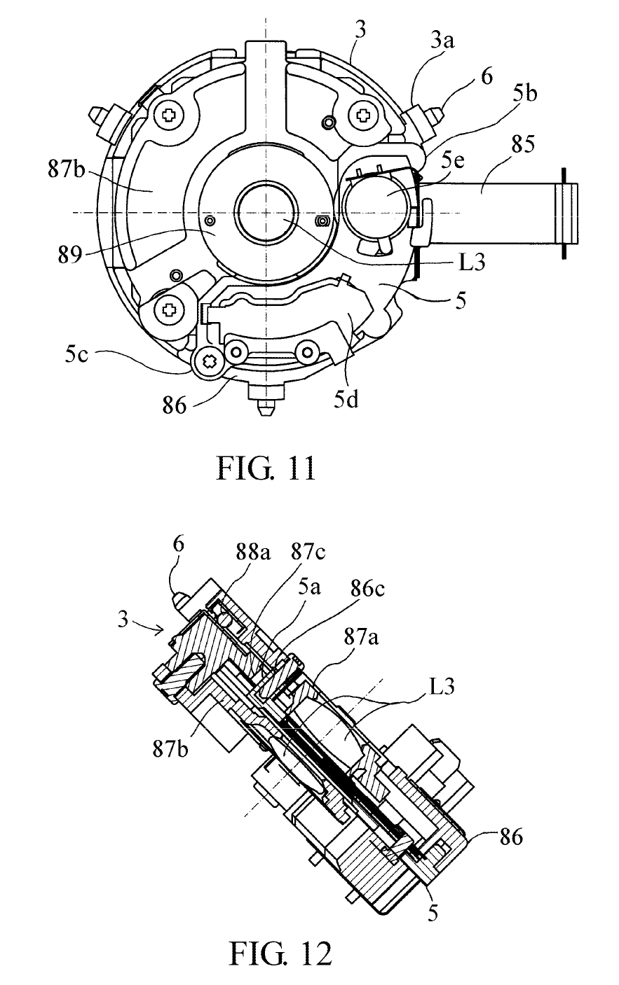

Next, description will be made of an assembling method of the light controlling and image stabilizing unit constituted by the aperture stop shutter unit 5 and the shift unit 3 with reference to FIGS. 5 and 11.

Attaching portions 5a, 5b and 5c formed on the aperture stop shutter unit 5 (aperture stop shutter base 500) are respectively brought into contact with receiving portions 86c, 86b and 86a formed on the shift unit 3 (shift base 86). The contact of the attaching portions 5a, 5b and 5c with the receiving portions 86c, 86b and 86a enables positioning of the aperture stop shutter unit 5 with respect to the shift base 86 in the optical axis direction. The aperture stop shutter unit is fixed to the shift unit 3 by screwing the attaching portion 5c to the receiving portion 86a.

The attaching portions (first attaching portions) 5b and 5c are respectively formed at the vicinities of the aperture stop motor 5e and the shutter motor 5d on an outer circumference of the aperture stop shutter unit 5 in consideration of a center of gravity of the aperture stop shutter unit 5. In other words, the attaching portions 5b and 5c are attached to the shift base 86 in an area outside a shiftable area (movable area) of the rear shift barrel 87a in the shift plane orthogonal to the optical axis.

Further, in the sector-shaped aperture stop shutter unit 5, only providing the attaching portions 5b and 5c at two places on the outer circumference of the aperture stop shutter unit 5 may generate a gap (backlash) between a center side part of the aperture stop shutter unit 5 and the shift base 86. Therefore, in this embodiment, the attaching portion (second attaching portion) 5a is added at a central (pivot) part of the sector-shaped aperture stop shutter unit 5. Thereby, the aperture stop shutter unit 5 is fixed to (supported by) the shift base 86 by being brought into contact with the shift base 86 at three points including the attaching portions 5a, 5b and 5c.

The attaching portion 5a extends through a through-opening 87c formed in the rear shift barrel 87a so as to penetrate through the rear shift barrel 87a in the optical axis direction, and makes contact with the receiving portion 86c. The through-opening 87c has a size and a shape that can prevent interference of a circumferential edge portion of the through-opening 87c with the attaching portion 5a even when the rear shift barrel 87a is shifted. Moreover, a positioning boss 5f is formed in a tip (distal) face of the attaching portion 5a. Insertion of the positioning boss 5f into a positioning hole 86d formed in the shift base 86 enables positioning of the aperture stop shutter unit 5 with respect to the shift base 86 in a rotation direction in a plane orthogonal to the optical axis.

The attaching portion 5a extends through the through-opening 87c as described above from the aperture stop shutter unit 5 to reach the rear shift barrel 87a.

As described above, in this embodiment, the aperture stop shutter unit 5 is attached to the shift base 86 at the attaching portions 5b and 5c provided in the area outside the shiftable area of the rear shift barrel 87a. Moreover, the aperture stop shutter unit 5 is also attached to the shift base 86 at the attaching portion 5a extending through the through-opening 87c formed in an inside area of the rear shift barrel 87a.

In other words, the shift base 86 is provided with the through-opening 87c in an area closer to the third lens unit (image stabilizing lens) L3 than an outer edge of the pitch shift actuator in pitch direction and an outer edge of the yaw shift actuator in the yaw direction, and the attaching portion 5a extends through the through-opening to be attached to the shift base 86.

Therefore, as compared with a case where the attaching portion 5a is provided in the area outside the shiftable area of the rear shift barrel 87a, the aperture stop shutter unit 5 can be more stably attached to the shift base 86 (shift unit 3) without increasing the size of the light controlling and image stabilizing unit.

The attaching portion 5a may be fixed to the shift base 86 by the following method as shown in FIG. 12. A screw hole is formed in the attaching portion 5a from its tip face, and a screw is inserted and tightened into the screw hole from a back face side of the receiving portion 86c of the shift base 86.

Then, in a state where the aperture stop shutter unit 5 is fixed to the shift base 86, the front shift barrel 87b disposed so as to sandwich the aperture stop shutter unit 5 with the rear shift barrel 87a is fixed to the rear shift barrel 87a by screws.

Thus, the assembly of the light controlling and image stabilizing unit is completed.

According to this embodiment, since the light controlling member is disposed in the thickness of the shift (image stabilizing) actuator, an extremely compact aperture stop shutter unit that is an optical unit can be achieved while having the light controlling function and the image stabilizing function.

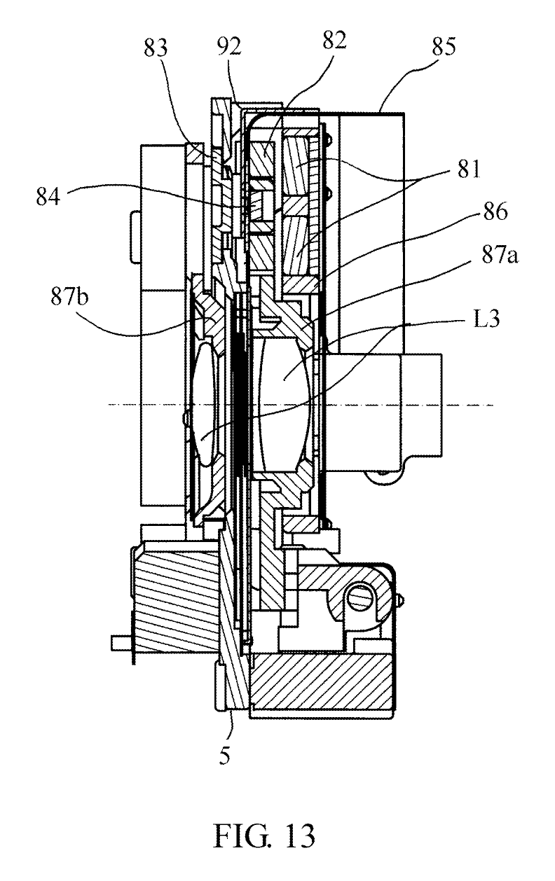

The above embodiment has described the case where the upper yokes 83 and 91 constituting part of the shift actuators are held by the rear shift barrel 87a. However, as shown in FIG. 13, the upper yoke 83 (and 91) may be held by the aperture stop shutter unit (aperture stop shutter base 500). In other words, part of the shift actuator may be held by the aperture stop shutter unit 5.

With such a configuration, though the attracting forces generated between the upper yokes 83 and 91 and the magnets 81 and 89 act on the aperture stop shutter unit 5, penetration of the attaching portion 5a through the rear shift barrel 87a makes it possible to dispose the attaching portion 5a near the upper yokes 83 and 91. Thereby, a structure can be achieved which is capable of preventing the aperture stop shutter unit 5 from being deformed by the above-described attracting forces.

However, a configuration is required which performs positioning of the shift barrel in the optical axis direction by using a guide bar, instead of the above-described configuration in which the shift barrel is brought into press contact with the balls by the attracting forces generated between the upper yokes 83 and 91 and the magnets 81 and 89. Further, it is necessary to provide a sheet metal 92 as a retaining member for the shift FPC 85 and the hall element 84, instead of the upper yoke.

The above embodiment has described the case, as an example case, where the light amount adjusting member 501 and the shutter members 502a and 502b are disposed in the thickness D of the shift actuators. However, a configuration may be employed in which at least one of these plural light controlling members is disposed in the thickness of the shift actuators.

Moreover, the above embodiment has described the case where a so-called moving coil type shift unit is used in which the coils and the magnets constituting the shift actuator are respectively held by the shift barrel and the shift base. However, a so-called moving magnet type shift unit may be used in which the magnets are held by the shift barrel and the coils are held by the shift base. In the case of using the moving magnet type shift unit, the through-opening 87c may be formed in an area of the rear shift barrel 87a closer to the third lens unit L3 (in other words, closer to the optical axis) than outer edges of the two magnets.

Furthermore, the above embodiment has described the case where the aperture stop shutter unit performing both the light amount adjusting operation and the shutter operation is attached to the shift unit. It is only necessary that the light controlling apparatus perform at least one of the light amount adjusting operation and the shutter operation.

In addition, the above embodiment has described the camera with the retractable lens barrel. However, alternative embodiments of the present invention may include other optical apparatuses such as a camera with a non-retractable lens barrel and an interchangeable lens.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2009-183376, filed on Aug. 6, 2009, which is hereby incorporated by reference herein in its entirety.

What is claimed is:

1. An optical unit comprising:
a base member;
a shift member configured to hold an image stabilizing lens and configured to be movable with respect to the base member in a plane orthogonal to an optical axis to reduce image blur;
an image stabilizing actuator configured to shift the shift member; and
a light controlling member disposed further inside than the image stabilizing actuator in a direction orthogonal to the optical axis and in an area where the image stabilizing actuator is disposed in a direction parallel to the optical axis.

2. An optical unit according to claim 1, wherein the light controlling member is used for performing at least one of a shutter operation and a light amount adjusting operation.

3. An optical unit according to claim 1,
wherein the optical unit includes as the image stabilizing actuator a first image stabilizing actuator configured to shift the shift member in a first direction in the plane orthogonal to the optical axis, and a second image stabilizing actuator configured to shift the shift member in a second direction in the plane orthogonal to the optical axis, the first and second directions being orthogonal to each other,
wherein the shift member is provided with an opening which penetrates through the shift member in the direction parallel to the optical axis in an area closer to the image stabilizing lens than an outer edge of the first image stabilizing actuator in the first direction and an outer edge of the second image stabilizing actuator in the second direction, and
wherein the light controlling member includes a first attaching portion which is attached to the base member in an area outside a movable area of the shift member in the plane orthogonal to the optical axis, and a second attaching portion which extends through the opening to be attached to the base member.

4. An optical apparatus comprising:
an optical unit according to claim 1.
